(19) United States
(12) Patent Application Publication
(10) Pub. No.: US 2025/0330432 A1
(43) Pub. Date: Oct. 23, 2025

(54) METHOD AND SYSTEM FOR SOLVING BYPASS-BASED MODULAR MULTI-CHIPLET DEADLOCK

(71) Applicant: National University of Defense Technology, Changsha City (CN)

(72) Inventors: Tiejun Li, Changsha City (CN); Jianmin Zhang, Changsha City (CN); Yi Dai, Changsha City (CN); Yi Yang, Changsha City (CN); Sheng Ma, Changsha City (CN); Lizhou Wu, Changsha City (CN); Bo Yang, Changsha City (CN)

(21) Appl. No.: 19/062,546

(22) Filed: Feb. 25, 2025

(30) Foreign Application Priority Data
Apr. 19, 2024 (CN) 2024104772584

(51) Int. Cl. H04L 49/505; H04L 47/62; H04L 49/90

(52) U.S. Cl. CPC H04L 49/508; H04L 47/6225; H04L 49/90

(57) ABSTRACT

A method and system for solving bypass-based modular multi-chiplet deadlock include polling each border router by means of time slice round-robin scheduling inside each chiplet; when processing upon arrival of the time slice of the border router, the border router is polled based on the internal time slice of the chiplet in a switchover manner to trigger the bypass mechanism of choke packets, and an output port is reserved between the border router and the destination router by using a look-ahead signal to build a bypass, and reserving a network interface and a rollback mechanism when the bypass packet pops up. The present disclosure aims at achieving deadlock-free in realizing bypass-based modular multi-chiplet design requirements in a multi-chiplet architecture under 2.5D packaging.

### TECHNICAL FIELD

The present disclosure relates to the technical field of on-chip network deadlock-free design for multi-chiplet systems, and in particular to a method and system for solving bypass-based modular multi-chiplet deadlock.

### BACKGROUND ART

In recent years, with the slowdown of Moore's Law and the complexity of chip functions, the cost of chips has been greatly increased. Firstly, the design of all functional units in a chip with the most advanced process greatly increases the design cost; secondly, more functional units and larger on-chip storage will lead to an increase in the area of the chip, which in turn leads to a decrease in the yield rate of chips and an increase in the production cost of chips. With the increasingly complex process technology, the cost of large-scale System on Chip (SoC) is constantly rising, which is a motivation for chiplet-based SoC design. This concept breaks down a traditional chip into several smaller chips, each of which is cheaper to develop, easier to reuse across multiple products and can be implemented using the most appropriate process technology. In a modular chiplet-based system, each chiplet can be designed separately from the SoC and can be reused in different SoCs to form a modular SoC.

As a new packaging technology, the 2.5D integration based on interposers is widely used in multi-chiplet systems. 2.5D packaging realizes high-density circuit connection of multiple chips by tiling dies on a silicon interposer with through silicon vias (TSVs). The interposer is a silicon substrate made of silicon and organic materials, which is the channel for transmitting electrical signals between multi-chip modules in advanced packaging. With the 2.5D advanced packaging technology, designers can integrate CPU, GPU, memory and I/O on the same substrate, which can shorten the distance between modules and ensure transmission bandwidth. This not only saves energy and cost, but also increases computational efficiency and provides greater design flexibility.

Deadlock is what is caused by cyclic resource dependency in the network. If no measures are taken to avoid or solve the deadlock, the correctness of the system cannot be guaranteed. FIG. 1 is a schematic diagram of a new deadlock (inter-chiplet deadlock) scenario in a 2.5D multi-chiplet integrated system. The two parallelograms on the upper side of the figure represent two chiplets, where a represents a border router, b represents a chiplet router, c represents an interposer router, and d represents an inter-chiplet deadlock. Due to the inter-chiplet deadlock, the inter-chiplet data loops without exit conditions, that is, a deadlock occurs. As shown in FIG. 2, the routings in a 2.5D multi-chiplet integrated system include intra-chiplet routing and inter-chiplet routing.

An intra-chiplet data packet refers to the data packet whose source node and destination node are located in the same chiplet. The routing of such packets follows the intra-chiplet routing algorithm. An inter-chiplet data packet means that the source node and the destination node are located on different chiplets respectively. The routing of such data packets can be divided into three segments: routing from the source node to a source chiplet border router, interposer routing, and routing from a destination chiplet border router to the destination node. The first segment follows a source chiplet routing rule, the second segment follows an interposer routing rule, and the third segment follows a destination chiplet routing rule. In this embodiment, based on the discovery that the inter-chiplet deadlock dependency must include at least one data packet forwarded upward by the interposer, a bypass is constructed in the third routing segment to ensure that the data packet forwarded upward by the interposer can reach the destination node. There have been many findings on deadlock problems in traditional 2D packaging, and these methods can be roughly divided into deadlock avoidance and deadlock recovery. The main methods of deadlock avoidance include: a Dally theory of building a loop-free Channel Dependency Graph (CDG), a Duato theory of maintaining a loop-free Escape VC, and a bubble flow control that keeps bubble buffers in the network. The main methods of deadlock recovery include: a deflection slice-based method; an SPIN that coordinates the synchronous movement of data packets along the deadlock loop; a DRAIN that periodically forces the movement of data packets along a predetermined path; a SWAP that exchanges choke packets locally to break the deadlock, etc.

The chiplet technology decomposes a single chip into multiple chiplets that are independently designed and produced and then integrates them, which brings new challenges to the design of network-on-chip. The first and most important challenge is the new deadlocks caused by inter-chiplet traffic. Even if the traditional 2D deadlock-free method is adopted in each chiplet and interposer to ensure that there is no deadlock, after multiple chiplets are integrated together through the interposer, inter-chiplet deadlock resource dependency may still occur in the whole system. This deadlock problem is difficult to perceive and solve when a single chiplet is designed independently, because the rest of the system is unknown at the moment. Moreover, in order to ensure the reusability of chiplets in different systems, the design of each chiplet should be able to be completed when information of the rest of the system is unknown, meeting the modular design requirements under a multi-chiplet architecture.

The design against deadlock in traditional 2D packaging does not support the modular design requirements under a multi-chiplet architecture. In recent years, some solutions to the new deadlock problems caused by multi-chiplet integration have been proposed, which can also be divided into two categories: deadlock avoidance and deadlock recovery. The deadlock avoidance methods include: MTR (See literature: Yin J, Lin Z, Kayiran O, et al. Modular routing design for chiplet-based systems [C]//2018 ACM/IEEE 45th Annual International Symposiumon Computer Architecture (ISCA). IEEE, 2018: 726-738.) Apply steering restrictions on border routers to build global loop-free channel dependency graphs; RC (See literature: Ma jumder P, Kim S, Huang J, et al. Remote control: A simple deadlock avoidance scheme for modular systems-on-chip [J]. IEEE Transactions on Computers, 2020, 70(11): 1928-1941.) Add a dedicated buffer for inter-chiplet traffic on the border router; DeFT (See literature: Taheri E, Pasricha S, Nikdast M. DeFT: A Deadlock-Free and Fault-Tolerant Routing Algorithm for 2.5 D Chiplet Networks [C]//2022 Design, Automation&Test in Europe Conference&Exhibition (DATE). IEEE, 2022: 1047-1052.) Using virtual network allocation to isolate the traffic of incoming and outgoing chiplets to avoid loop resource dependency. The deadlock recovery methods mainly include: UPP (See literature: Wu Y, Wang L, Wang X, et al. Upward packet popup for deadlock freedom in modular chiplet-based systems [C]//2022 IEEE International Symposium on HighPerformance Computer Architecture (HPCA). IEEE, 2022: 986-1000.) Perform deadlock recovery by timeout deadlock detection and synchronization protocol based on signal handshake.

However, the existing deadlock-free designs for 2.5D multi-chiplet systems all have problems of limited network performance and high overhead: MTR calculates the steering restrictions offline through an enumeration algorithm. The high complexity of the algorithm limits the scalability of the system, and the path diversity is compromised after applying the steering restrictions. The extra dedicated buffer added by RC greatly increases the area overhead of the border router, and when injecting inter-chiplet traffic, it is necessary to apply for an idle dedicated buffer of the border router first, which increases the delay of inter-chiplet data packets. At the same time, the inter-chiplet data packets waiting for approval will stay in the injection queue of network interface (NI) and block the normal injection of subsequent data packets. With the DeFT method, a virtual network allocation is used to realize inter-chiplet traffic isolation, which requires at least 2VC in the network. At the same time, virtual network allocation rules also limit packet forwarding conditions, thus increasing delay overhead. With the UPP method, it is needed to add a complex deadlock recovery mechanism, and the false positives and hysteresis of deadlock detection will have great impact on network performance. In addition, existing deadlock-free designs for 2.5D multi-chiplet systems generally have the problem of restricting selection of border routers for inter-chiplet data packets. The inter-chiplet data packet routing can be divided into three segments: routing from the source node to a source chiplet border router, interposer routing, and routing from a destination chiplet border router to the destination node. It involves two selections of border routers, i.e. source chiplet border router and destination chiplet border router, respectively. Previous designs have generally had problems limiting the choice of these two border routers: The permission network in RC binds each chiplet router to a specific border router statically, so that the chiplet router can only send inter-chiplet data packets through the border router, which limits the first selection of border routers; with MTR, it is needed to impose diversion restrictions on the border router, which affects the transmission and reception of inter-chiplet data packets by chiplet routers, thus restricting both selections of border routers; with UPP, it is needed to statically bind the chiplet router to the border router to ensure that there is no collision in handshake signal transmission before deadlock recovery, which limits the second selection of border routers. Restrictions on the selection of border routers will compromise the path diversity of inter-chiplet data packet transmission, and are not conducive to load balancing among border routers. Moreover, when links or nodes fail in the network, some nodes in the network may be unreachable, thus causing the whole system to crash.

### SUMMARY

The technical problems to be solved by the present disclosure: In view of the above problems in the prior art, a method and system for solving bypass-based modular multi-chiplet deadlock are provided. The present disclosure aims at achieving deadlock-free in realizing bypass-based modular multi-chiplet design requirements in a multi-chiplet architecture under 2.5D packaging.

In order to solve the above technical problems, the present disclosure claims a technical solution as follows:

A method for solving bypass-based modular multi-chiplet deadlock, comprises polling each border router by means of time slice round-robin scheduling inside each chiplet, and the processing when the time slice of the border router arrives comprises:
S1, judging whether there is a choke packet forwarded upward by an interposer whose choke time exceeds the threshold in the buffer, if yes, skipping to S2; otherwise, judging whether there is a rollback upgrade packet in the injection queue of the network interface, if yes, skipping to S4, and if no rollback upgrade packet exists, there is no action during this time slice, ending and exiting;
S2. setting the choke packet in the buffer as an upgrade packet, popping the upgrade packet up from the buffer and routing it downward along a bypass;
S3: judging whether there is a rollback upgrade packet in the injection queue of the network interface, if yes, injecting it from the injection queue of the network interface into the buffer where the choke packet pops up, and if no, returning credit to the upstream router;
S4, constructing a bypass downward for the upgrade packet to route to the destination network interface by using the bypass;
S5, judging whether the pop-up queue of the destination network interface is full or not, if no, then determining that the bypass routing of the upgrade packet has been completed and this time slice ends and exits; otherwise, making reservation in the pop-up queue of the destination network interface, and then returning to the original border router along the bypass so as to be cached in the injection queue of the network interface of the original border router; and
S6: judging whether the injection queue of the network interface of the original border router is full or not, if yes, discarding the head data packet of the injection queue to cache the rollback upgrade packet, otherwise directly caching the rollback upgrade packet, and exiting after this time slice ends.

Optionally, when comprising round-robin scheduling time slices among multiple border routers on the same chiplet, the length of the adopted time slice K≥2×d, and d is the length of the farthest path reachable by the border router.

Optionally, constructing the bypass downward for the upgrade packet in S4 refers to using a look-ahead signal to reserve an output port of the next-hop router for which it applies for.

Optionally, after discarding the head data packet of the injection queue in S6, the method further comprises: after the transaction corresponding to the data packet cannot be completed due to the operation of discarding the head data packet of the injection queue and is perceived by the source node corresponding to the data packet at an upper layer through Miss-Status Handling Registers (MSHRs), the source node corresponding to the data packet perceives the discarding operation of the data packet, regenerates the transaction corresponding to the data packet and injects a request into the network again.

Optionally, the injection queue is a buffer located at a network interface.

Optionally, the pop-up queue is a buffer located at a network interface.

In addition, the present disclosure further provides a modular multi-chiplet microprocessor, comprising multiple chips and a silicon interposer with through silicon vias, the dies of the multiple chips being tiled on the silicon interposer with through silicon vias to realize interconnection of the multiple chips. The modular multi-chiplet microprocessor is programmed or configured to implement the method for solving bypass-based modular multi-chiplet deadlock.

In addition, the present disclosure further provides an electronic device comprising a microprocessor and a memory connected to each other, and the microprocessor is the modular multi-chiplet microprocessor.

In addition, the present disclosure further provides a computer-readable storage medium, the computer-readable storage medium having stored therein a computer program/instructions. The computer program/instructions are programmed or configured to implement the method for solving bypass-based modular multi-chiplet deadlock.

In addition, the present disclosure further provides a computer program product, comprising a computer program/instructions. The computer program/instructions are programmed or configured to implement the method for solving bypass-based modular multi-chiplet deadlock.

Compared with the prior art, the present disclosure mainly has the following advantages:
1. The method for solving bypass-based modular multi-chiplet deadlock of the present disclosure has no restriction on routing design and number of virtual channels inside each chiplet and interposer, and it is not needed to add additional buffers and synchronization protocols.
2. The method for solving bypass-based modular multi-chiplet deadlock of the present disclosure has no restriction on two selections of border routers in inter-chiplet data packet routing, and ensures path diversity of inter-chiplet data packet transmission.
3. When the network configuration is the same, the present disclosure realizes a better network transmission rate.

### BRIEF DESCRIPTION OF DRAWINGS

FIG. 1 is a schematic diagram of a new deadlock scenario in a 2.5D multi-chiplet integrated system in the prior art.

FIG. 2 is a schematic diagram of intra-chiplet and inter-chiplet data packet transmission in the prior art.

FIG. 3 is a schematic flow chart of a method according to an embodiment of the present disclosure.

FIG. 4 is a schematic diagram of an example in which the choke packet b is set as the upgrade packet u and pops up to the bypass according to an embodiment of the present disclosure.

FIG. 5 is a schematic diagram of bypassing the upgrade packet u to the destination node and popping it up in an embodiment of the present disclosure.

FIG. 6 is a schematic diagram of returning the upgrade packet u to the original border router along the bypass in an embodiment of the present disclosure.

FIG. 7 is a schematic diagram illustrating that the upgrade packet u rolled back in the previous time slice is used as the new upgrade packet u′ in this time slice according to an embodiment of the present disclosure.

FIG. 8 is a schematic diagram of bypass construction in an embodiment of the present disclosure.

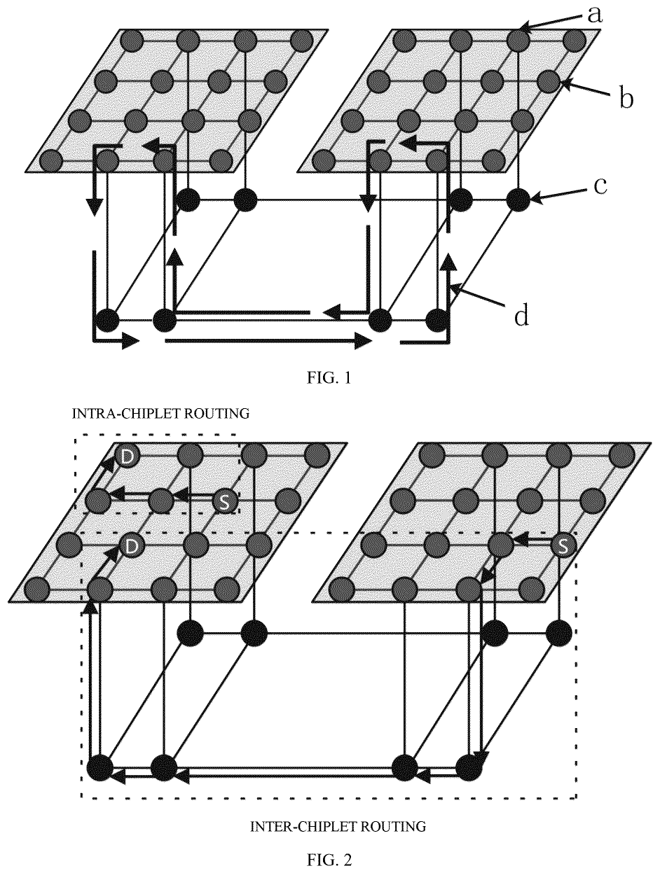

### DETAILED DESCRIPTION OF THE PREFERRED EMBODIMENTS

The method for solving bypass-based modular multi-chiplet deadlock of this embodiment assumes that each chiplet and routing inside the interposer implement no deadlock, and a deadlock in the system may only occur in an inter-chiplet scenario. The key to the method for solving bypass-based modular multi-chiplet deadlock of this embodiment is that the border router is polled based on the internal time slice of the chiplet in a switchover manner to trigger the bypass mechanism of choke packets, and an output port is reserved between the border router and the destination router by using a look-ahead signal to build a bypass, and reserving a network interface and a rollback mechanism when the bypass packet pops up, so as to provide a bypass-based deadlock-free solution meeting the requirements of multi-chiplet modular design for the multi-chiplet architecture under 2.5D packaging. The flow control policy used is Virtual Cut-Through (VCT), and the depth of the virtual channel is sufficient to cache the longest data packet in the network, which will be further described in detail below. It should be noted that the following embodiments will help those skilled in the art to further understand the disclosure, but do not limit the disclosure in any form. The present disclosure is applicable to all 2.5D integrated multi-chiplet systems and is not limited to this embodiment.

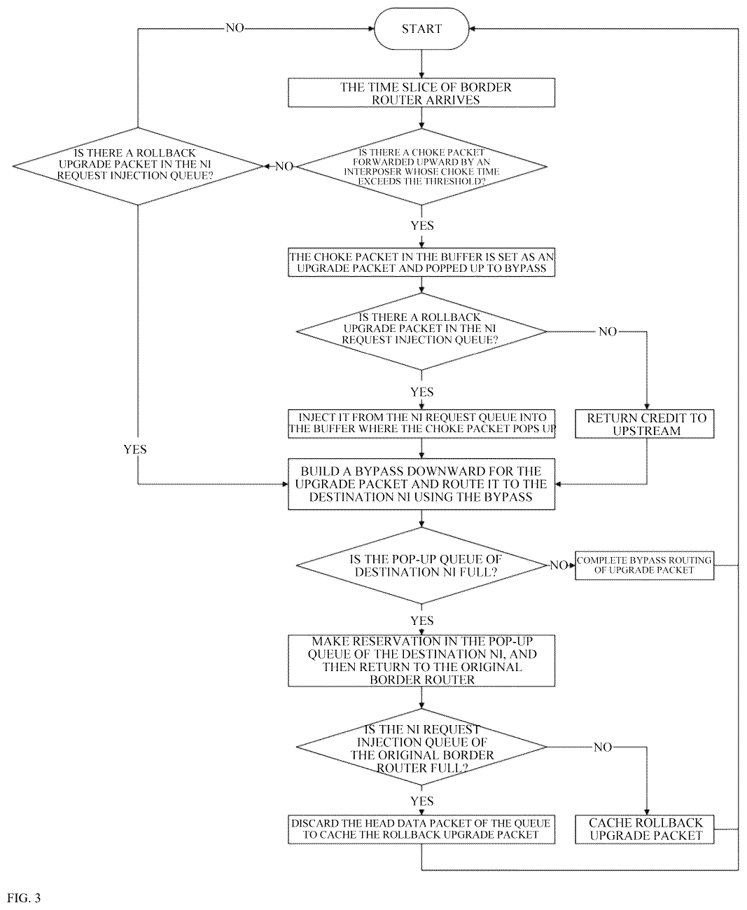

As shown in FIG. 3, the method for solving bypass-based modular multi-chiplet deadlock of this embodiment, comprises polling each border router by means of time slice round-robin scheduling inside each chiplet, and the processing when the time slice of the border router arrives comprises:
S1, judging whether there is a choke packet forwarded upward by an interposer whose choke time exceeds the threshold in the buffer, if yes, skipping to S2; otherwise, judging whether there is a rollback upgrade packet in the injection queue of the network interface, if yes, skipping to S4, and if no rollback upgrade packet exists, there is no action during this time slice, ending and exiting;
S2. setting the choke packet in the buffer as an upgrade packet, popping the upgrade packet up from the buffer and routing it downward along a bypass;
S3: judging whether there is a rollback upgrade packet in the injection queue of the network interface, if yes, injecting it from the injection queue of the network interface into the buffer where the choke packet pops up, and if no, returning credit to the upstream router;
S4, constructing a bypass downward for the upgrade packet to route to the destination network interface by using the bypass;
S5, judging whether the pop-up queue of the destination network interface is full or not, if no, then determining that the bypass routing of the upgrade packet has been completed and this time slice ends and exits; otherwise, making reservation in the pop-up queue of the destination network interface, and then returning to the original border router along the bypass so as to be cached in the injection queue of the network interface of the original border router; and
S6: judging whether the injection queue of the network interface of the original border router is full or not, if yes, discarding the head data packet of the injection queue to cache the rollback upgrade packet, otherwise directly caching the rollback upgrade packet, and exiting after this time slice ends.

In the method of this embodiment, each border router is polled by means of time slice round-robin scheduling inside each chiplet to give each border router an opportunity to bypass choked data packets into the chiplet. By ensuring that the data packet forwarded upward by the interposer can reach its destination node, there will be no inter-chiplet cyclic resource dependency in the network all the time, thus solving the deadlock of the multi-chiplet system. The method of this embodiment has no restriction on the routing design and the number of virtual channels inside each chiplet and interposer. There is no restriction on the selection of border routers in inter-chiplet data packet transmission to ensure the path diversity of inter-chiplet data packet routing. Each chiplet can be designed independently without other module information of the system, which ensures that the chiplet can be designed in a modular manner and guarantees the flexibility and reusability of the chiplet. The method for solving bypass-based modular multi-chiplet deadlock provided in this embodiment is suitable for an inter-chiplet deadlock scenario caused by integrating multiple chiplets through an active interposer under the condition that there is no deadlock inside each chiplet and the active interposer. The method for solving bypass-based modular multi-chiplet deadlock provided in this embodiment supports that each chiplet is independently designed in a modular manner regardless of the system globality, and there is no restriction on design of the routing inside each chiplet and the active interposer. The method for solving bypass-based modular multi-chiplet deadlock provided in this embodiment focuses on dredging vertical link choke to improve the transmission rate of the network. In this embodiment, when comprising time slice round-robin scheduling among multiple border routers on the same chiplet, with the adopted length of the time slice K≥2×d, and d is the length of the farthest path reachable by the border router, so that the depth of the virtual channel can be sufficient to cache the longest data packet in the network.

In this embodiment, constructing the bypass downward for the upgrade packet in S4 refers to using a look-ahead signal to reserve an output port of the next-hop router for which it applies for.

In this embodiment, after discarding the head data packet of the injection queue in S6, the method further comprises: after the transaction corresponding to the data packet cannot be completed due to the operation of discarding the head data packet of the injection queue and is perceived by the source node corresponding to the data packet at an upper layer through Miss-Status Handling Registers (MSHRs), the source node corresponding to the data packet perceives the discarding operation of the data packet, regenerates the transaction corresponding to the data packet and injects a request into the network again.

In this embodiment, the injection queue is a buffer located at a network interface.

In this embodiment, the pop-up queue is a buffer located at a network interface.

As mentioned above, the routing in 2.5D multi-chiplet integration system includes intra-chiplet routing and inter-chiplet routing. Correspondingly, data packets in 2.5D integrated multi-chiplet architecture can be divided into two categories: intra-chiplet data packets and inter-chiplet data packets. An intra-chiplet data packet refers to a data packet in which the source node and destination node are both located inside the same chiplet; an inter-chiplet data packet refers to a data packet in which the source node and destination node are respectively located inside different chiplets. An intra-chiplet data packet refers to the data packet whose source node and destination node are located in the same chiplet. The routing of such packets follows the intra-chiplet routing algorithm. An inter-chiplet data packet means that the source node and the destination node are located on different chiplets respectively. The routing of such data packets can be divided into three segments: routing from the source node to a source chiplet border router, interposer routing, and routing from a destination chiplet border router to the destination node. The first segment follows a source chiplet routing rule, the second segment follows an interposer routing rule, and the third segment follows a destination chiplet routing rule. In this embodiment, based on the discovery that the inter-chiplet deadlock dependency must include at least one data packet forwarded upward by the interposer, a bypass is constructed in the third routing segment to ensure that the data packet forwarded upward by the interposer can reach the destination node. The method for solving bypass-based modular multi-chiplet deadlock of this embodiment is based on the premise that there is no deadlock inside each chip and interposer, and at this time, a deadlock in the system can only be formed by inter-chiplet cyclic dependencies. In this embodiment, each border router is polled by means of time slice round-robin scheduling inside each chiplet. Globally, the round-robin in multiple chiplets are independent and do not affect each other. Globally, each border router obtains a time slice at a stable period and can trigger the bypass mechanism of choke packets to dredge traffic forwarded upward by an interposer. The choke packet bypass mechanism combines with the reservation of network interface and rollback mechanism when the bypass packet pops up, which ensures that the data packet forwarded upward by the interposer will eventually reach the destination node and pop up. In the method for solving bypass-based modular multi-chiplet deadlock of this embodiment, by ensuring that data packets forwarded upward by the interposer can reach (its destination node), the inter-chiplet cyclic dependency will not always exist in the network, thereby ensuring that the system will not fall into a deadlock.

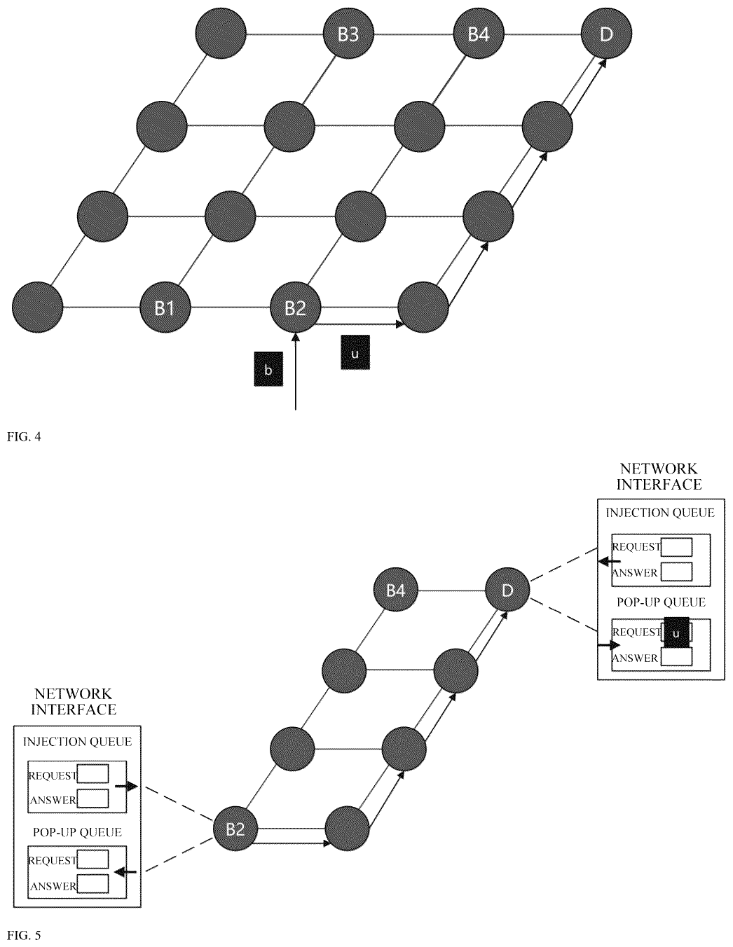

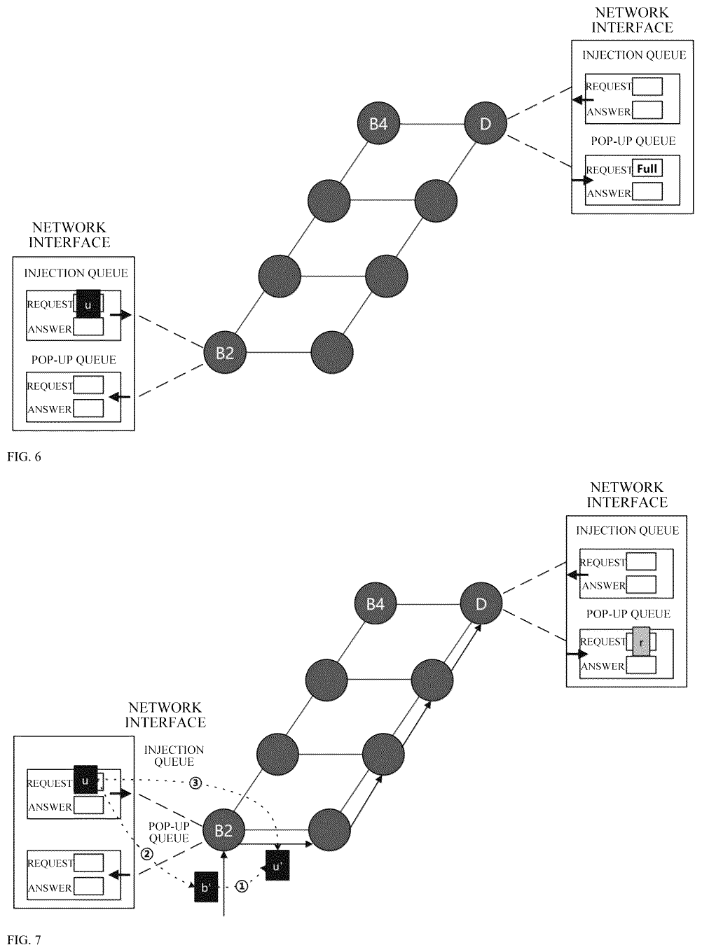

In order to more clearly illustrate the method for solving bypass-based modular multi-chiplet deadlock proposed in this design, see FIGS. 4-7, the specific embodiments. It should be noted that FIGS. 4-7 are only a specific scenario in which the embodiment can be applied, and do not limit the application of the embodiment to this scenario only. The embodiment is widely applicable to 2.5D integrated multi-chiplet homogeneous or heterogeneous systems. Taking a chiplet in the architecture as an example, when the time slice of the border router B2 arrives, it is judged that there is a choke packet b whose choke time exceeds the threshold in the data packet forwarded upward by the interposer, and then it is set as an upgrade packet u and popped up to bypass, as shown in FIG. 4. Specifically, a bypass from the destination chiplet border router to the destination node is constructed by reserving an output port of the downstream router downward using the look-ahead signal, and the upgrade packet u is bypassed to the destination node and popped up to the network interface pop-up queue, as shown in FIG. 5. Specifically, if the pop-up queue of the destination node is full, reservations are made in the pop-up queue of the destination node, and then the upgrade packet u is returned to the original border router along the bypass, cached to the network interface request injection queue of the original border router, as shown in FIG. 6. if the network interface request injection queue of the original border router is full, discard the head data packet of the queue to cache the rollback upgrade packet u. Specifically, before the next time slice of the border router B2 arrives, if there is an idle input buffer in a direction from the interposer to B2, this rollback upgrade packet is injected into the idle buffer. Specifically, when the next time slice of the border router B2 arrives, if there is a new choke packet b′ forwarded upward by the interposer at this time, and there is still an upgrade packet u rolled back in the previous time slice in the network interface request injection queue at B2, then the new choke packet b′ is set as an upgrade packet u′ and popped up to the bypass, and meanwhile, the rollback upgrade packet u is cached in the empty buffer of b′. If there is no new choke packet forwarded upward by the interposer, the upgrade packet u rolled back in the previous time slice is taken as a new upgrade packet u′ in this time slice, as shown in FIG. 7.

In the method for solving bypass-based modular multi-chiplet deadlock of this embodiment, packet discarding only occurs when the network interface pop-up queue at the destination node of the upgrade packet is full and the network interface request injection queue of the original border router is full, so the probability of packet discarding is extremely low. The rollback upgrade packet will not be discarded because it resides in the network interface request injection queue. This is because when the same border router generates a new upgrade packet again and pops it up to the bypass, the rollback upgrade packet will be injected into the buffer vacated by this new upgrade packet instead of remaining in the network interface request injection queue. Therefore, even if a new upgrade packet is rolled back to the original border router, it will not be discarded. Therefore, the discarded data packet is a data packet generated by an upper terminal node connected to the border router and not been injected into the network and can be regenerated by a Miss-status Handling Register (MSHR). The network interface pop-up queue of the destination node will not always be full. If the response pop-up queue is full: the upper terminal will eventually process the response; if the request pop-up queue is full: the request will not be processed by the upper terminal because the preceding response has not been received, and the preceding response finally arrives at the dredging of the mechanism for solving bypass-based modular multi-chiplet deadlock proposed in this embodiment and will be processed by the upper terminal, so that the requests can be further consumed to make the request pop-up queue idle. Ordinary data packets will not be starved to death due to the preemption of output ports during the bypass process of upgrade packets. The upgrade packet will reserve output ports downward from the border router, that is to say, the upgrade packet has the highest priority in routing in the network. This will cause ordinary data packets to be temporarily preempted on the same output port as it requests, but will not cause starvation of ordinary data packets. This is because even if the upgrade packet temporarily preempts the ordinary data packet after reserving an output port by using a look-ahead signal, the ordinary data packet still continues to apply for an output port according to fairness arbitration at the current node after the upgrade packet is forwarded downward. In addition, an upgrade packet does not always exist in a chiplet network because several conditions need to be satisfied at the same time:

Condition 1: The choke continues at each border router, so that the choke packet is always set as an upgrade packet;

Condition 2: The routing path length of each upgrade packet is the farthest path d that can be reached by the border router, with the time slice length K=2×d;

Condition 3: The network interface pop-up queue at the destination node of each upgrade packet is full, so it must be returned through the original path.

According to the above discussion, the pop-up queue will not be infinitely full, so Condition 3 will not always hold. There will eventually be time for only ordinary data packets in the network, and ordinary data packets will not starve to death.

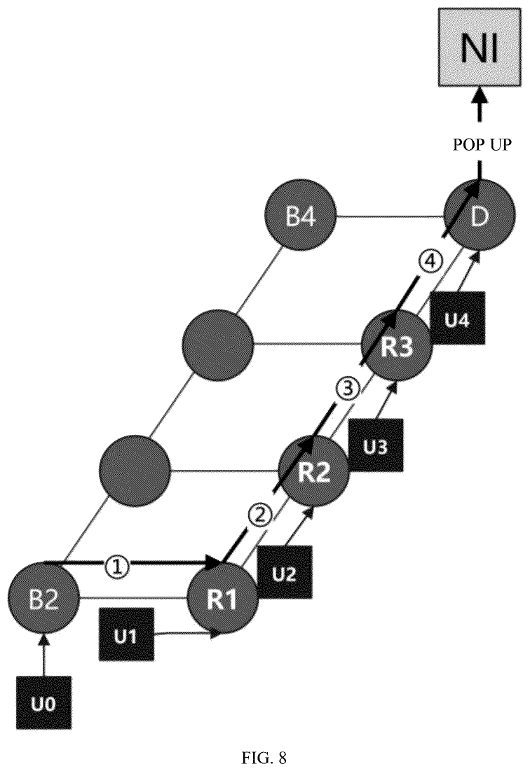

FIG. 8 is a schematic diagram of bypass construction in this embodiment. Compared with the deadlock recovery method, which requires coordinating resources or adding additional buffers to break the deadlock, in this embodiment, it is only needed to reserve an output port by using a look-ahead signal to build a bypass for the upgrade packet, and the whole process does not involve buffer resources. Taking FIG. 8 as an example, when the upgrade packet U is located in the border router B2 (state: U0), a look-ahead signal carrying information of the destination node is transmitted to the downstream R1 (arrow \textcircled{1}), and R1 reserves an output port for transmission to R2. After U arrives at R1 (state: U1), the look-ahead signal (arrow \textcircled{2}) continues to be transmitted downward, and R2 is its output port reserved for transmission to R3. By analogy, when U is at R3 (state: U3), the local output port of D is reserved with a look-ahead signal to be popped to NI, and if there is space in the NI pop queue, it is popped up to NI via D (state: U4 to pop up). From this example, it can be seen that there is no operation of buffering data packets to the buffer in the whole process to involving the transmission of look-ahead signals and the reservation of output ports (which has not been proposed in the existing 2.5D multi-chiplet deadlock-free design). If the pop-up queue of network interface (NI) is full, it will be sensed by D when R3 transmits a look-ahead signal to D to reserve the output port from D to NI, so as to make reservation in the corresponding pop-up queue of NI. Then, D builds a bypass backward to B2 and returns to U (reverse the process in the figure).

To sum up, the method for solving bypass-based modular multi-chiplet deadlock in this embodiment includes polling a border router based on the internal time slice of the chiplet in a switchover manner to trigger the bypass mechanism of choke packets; constructing a bypass between the border router and the destination router; and reserving a network interface and a rollback mechanism when the bypass packet pops up. In this embodiment, the deadlock in a multi-chiplet architecture is effectively solved by ensuring that all data packets forwarded upward by an interposer can reach its destination node and that there will not always be a deadlock caused by inter-chiplet cyclic dependency in the network. Compared with other existing technologies, the method for solving bypass-based modular multi-chiplet deadlock of this embodiment does not impose any routing restriction and ensures path diversity of data packet transmission. No additional buffer is added, but the output port is reserved downward by the look-ahead signal to build a bypass transmission. Double selection of border routers when data packets are transmitted across chiplets is not restricted. It greatly supports the independent modular design of each chiplet in a multi-chiplet system, ensuring the reusability advantage of chiplets. The method for solving bypass-based modular multi-chiplet deadlock of this embodiment preempts the output port for a short time only when the upgrade packet is routed downward by bypassing, so that the transmission of ordinary packets is slightly delayed, and the transmission of most data packets in the system is not affected, thus achieving a more excellent transmission efficiency. The method for solving bypass-based modular multi-chiplet deadlock provided in this embodiment sets no restriction on the selection of border routers in the inter-chiplet data packet routing process, no restriction on the algorithm design of routing inside each chiplet and interposer, and no restriction on the number of virtual channels deployed in the system. The method proposed in this embodiment has no path for routing data packets in the network, so it will not cause a livelock. The action domain of this embodiment is one chiplet, and the chiplet can ensure that it will not fall into an inter-chiplet deadlock by applying the method of this embodiment. When the method of this embodiment is globally applied to each chiplet, multiple chiplets do not affect each other and independently round-robin their respective time slice in a parallel manner, and the length of the time slice and the choke threshold can be individually designed according to the needs of each chiplet (parameters are configurable). This embodiment does not utilize a synchronization protocol to complete the construction of bypasses.

For the inter-chiplet deadlock in 2.5D multi-chiplet integrated systems, three strategies have been proposed: turn restriction, virtual channel isolation and deadlock recovery. Compared with the existing design, the advantages and characteristics of the method in this embodiment are summarized as follows: 1. Supporting fully adaptive routing (different from the method based on turn restriction): In this embodiment, there is no restriction on the routing algorithm adopted by each chiplet and inside the interposer, and there is no restriction on the selection of border routers in the inter-chiplet data packet transmission path. Therefore, from a global point of view, this embodiment can support fully adaptive routing. 2. No need to add additional virtual channels (different from the method based on virtual channel allocation): The design that uses virtual channels to isolate traffic transferred into and out of chiplets can also support fully adaptive routing, but it limits the global minimum number of virtual channels to at least 2. This embodiment has no such limitation, and allows each module in the 2.5D multi-chiplet system to independently configure the number of virtual channels according to the network scale and traffic load requirements. 3. Ignoring whether a deadlock really occurs (different from the method based on the deadlock recovery strategy): Different from other methods, which are both based on deadlock avoidance and deadlock recovery, this embodiment does not distinguish whether a deadlock actually occurs, and can solve the deadlock while alleviating choke. 4. The action domain of this embodiment is an independent single chiplet, which is decoupled from the complete system and truly meets the modular design requirements.

Those skilled in the art know that the method for solving bypass-based modular multi-chiplet deadlock provided in this embodiment can be implemented by adding logic gates, switches, application-specific integrated circuits, programmable logic controllers and embedded microcontrollers. In addition, this embodiment further provides a modular multi-chiplet microprocessor, comprising multiple chips and a silicon interposer with through silicon vias, the dies of the multiple chips being tiled on the silicon interposer with through silicon vias to realize interconnection of the multiple chips. The modular multi-chiplet microprocessor is programmed or configured to implement the method for solving bypass-based modular multi-chiplet deadlock.

In addition, this embodiment further provides an electronic device comprising a microprocessor and a memory connected to each other, and the microprocessor is the modular multi-chiplet microprocessor.

In addition, this embodiment further provides a computer-readable storage medium, the computer-readable storage medium having stored therein a computer program/instructions. The computer program/instructions are programmed or configured to implement the method for solving bypass-based modular multi-chiplet deadlock.

In addition, this embodiment further provides a computer program product, comprising a computer program/instructions. The computer program/instructions are programmed or configured to implement the method for solving bypass-based modular multi-chiplet deadlock.

Those skilled in the art shall understand that the embodiments of the present application may be provided as a method, a system or a computer program product. Therefore, the present application may be in the form of complete hardware embodiments, complete software embodiments, or software-hardware combined embodiments. Furthermore, the present application may take the form of a computer program product implemented on one or more computer-readable storage media (comprising but not limited to disk memory, CD-ROM, optical memory, etc.) including computer-usable program codes. The present application is described with reference to flowcharts and/or block diagrams of the method, the device (system), and the computer program product according to the embodiments of the present application. It should be understood that, each flow and/or block in the flowcharts and/or block diagrams, as well as the combination of flow and/or block in the flowcharts and/or block diagrams can be implemented by computer program instructions. The computer program instructions may be provided to general-purpose computers, special-purpose computers, embedded processors or processors of other programmable data processing devices to produce a machine, so that a device for realizing the functions specified in one or multiple flows in the flowchart and/or one or multiple blocks in the block diagram is generated by the instructions to be executed by computers or processors of other programmable data processing devices. The computer program instructions may also be stored in a computer-readable memory capable of directing a computer or other programmable data processing devices to operate in a particular manner, so that the instructions stored in the computer-readable memory produce an article of manufacture including a command device, and the command device implements the functions specified in one or multiple flows in the flowchart and/or one or multiple blocks in the block diagram. The computer program instructions may also be loaded onto a computer or other programmable data processing devices such that a series of operational steps are performed on the computer or other programmable devices to produce a computer-implemented process, whereby the instructions executed on the computer or other programmable devices provide steps for implementing the functions specified in one or multiple flows in the flowchart and/or one or multiple blocks in the block diagram.

The above are only preferred embodiments of the present disclosure, and the protection scope of the present disclosure is not limited to the above embodiments. All technical solutions under the idea of the present disclosure shall fall within the protection scope of the present disclosure. It should be pointed out that for ordinary technical personnel in this field. several improvements and modifications without departing from the principle of the disclosure shall also be deemed as the protection scope of the disclosure.

1. A method for solving bypass-based modular multi-chiplet deadlock, wherein it comprises polling each border router by means of time slice round-robin scheduling inside each chiplet, and the processing when the time slice of the border router arrives comprises:
S1, judging whether there is a choke packet forwarded upward by an interposer whose choke time exceeds the threshold in the buffer, if yes, skipping to S2; otherwise, judging whether there is a rollback upgrade packet in the injection queue of the network interface, if yes, skipping to S4, and if no rollback upgrade packet exists, there is no action during this time slice, ending and exiting;
S2. setting the choke packet in the buffer as an upgrade packet, popping the upgrade packet up from the buffer and routing it downward along a bypass;
S3: judging whether there is a rollback upgrade packet in the injection queue of the network interface, if yes, injecting it from the injection queue of the network interface into the buffer where the choke packet pops up, and if no, returning credit to the upstream router;
S4, constructing a bypass downward for the upgrade packet to route to the destination network interface by using the bypass;
S5, judging whether the pop-up queue of the destination network interface is full or not, if no, then determining that the bypass routing of the upgrade packet has been completed and this time slice ends and exits; otherwise, making reservation in the pop-up queue of the destination network interface, and then returning to the original border router along the bypass so as to be cached in the injection queue of the network interface of the original border router; and
S6: judging whether the injection queue of the network interface of the original border router is full or not, if yes, discarding the head data packet of the injection queue to cache the rollback upgrade packet, otherwise directly caching the rollback upgrade packet, and exiting after this time slice ends.

2. The method for solving bypass-based modular multi-chiplet deadlock according to claim 1, wherein when comprising round-robin scheduling time slices among multiple border routers on the same chiplet, the length of the adopted time slice K≥2×d, and d is the length of the farthest path reachable by the border router.

3. The method for solving bypass-based modular multi-chiplet deadlock according to claim 1, wherein constructing the bypass downward for the upgrade packet in S4 refers to using a look-ahead signal to reserve an output port of the next-hop router for which it applies for.

4. The method for solving bypass-based modular multi-chiplet deadlock according to claim 1, wherein after discarding the head data packet of the injection queue in S6, the method further comprises: after the transaction corresponding to the data packet cannot be completed due to the operation of discarding the head data packet of the injection queue and is perceived by the source node corresponding to the data packet at an upper layer through Miss-Status Handling Registers (MSHRs), the source node corresponding to the data packet perceives the discarding operation of the data packet, regenerates the transaction corresponding to the data packet and injects a request into the network again.

5. The method for solving bypass-based modular multi-chiplet deadlock according to claim 1, wherein the injection queue is a buffer located at a network interface.

6. The method for solving bypass-based modular multi-chiplet deadlock according to claim 1, wherein the pop-up queue is a buffer located at a network interface.

7. A modular multi-chiplet microprocessor, comprising multiple chips and a silicon interposer with through silicon vias, the dies of the multiple chips being tiled on the silicon interposer with through silicon vias to realize interconnection of the multiple chips, wherein the modular multi-chiplet microprocessor is programmed or configured to implement the method for solving bypass-based modular multi-chiplet deadlock according to claim 1.

8. An electronic device comprising a microprocessor and a memory connected to each other, the microprocessor being the modular multi-chiplet microprocessor according to claim 7.

9. A computer-readable storage medium, the computer-readable storage medium having stored therein a computer program/instructions, wherein the computer program/instructions are programmed or configured to implement the method for solving bypass-based modular multi-chiplet deadlock according to claim 1.

10. A computer program product, comprising a computer program/instructions, wherein the computer program/instructions are programmed or configured to implement the method for solving bypass-based modular multi-chiplet deadlock according to claim 1.
